(19) United States
(12) Patent Application Publication
(10) Pub. No.: US 2012/0056471 A1
(43) Pub. Date: Mar. 8, 2012

(54) Braking System for a Land Vehicle with Regenerative Braking Functionality

(75) Inventors: Heinrich Plewnia, Niederhofen (DE); Leo Gilles, Koblenz (DE); Michael Keller, Traisen (DE); Boris Koeth, Weitersburg (DE)

(73) Assignee: LUCAS AUTOMOTIVE GMBH, Koblenz (DE)

(21) Appl. No.: 13/202,186

(22) PCT Filed: Feb. 18, 2010
(86) PCT No.: PCT/EP2010/001034

§ 371 Date: Sep. 14, 2011

(30) Foreign Application Priority Data
Feb. 19, 2009 (DE) 10 2009 009 647.7

(51) Int. Cl. B60T 13/58; B60T 8/176; B60T 13/66

(52) U.S. Cl. 303/3; 303/113.1

(57) ABSTRACT

A brake unit for a hydraulic, single- or multi-circuit brake system of a land vehicle with electric drive for carrying out regenerative braking by means of at least one electrical machine in or at the drive train of the vehicle and braking by means of at least one friction brake, wherein a brake pedal and at least one sensor for detecting a braking request of the driver is provided, a master cylinder for feeding pressurized hydraulic fluid into at least one brake circuit in accordance with the braking request, wherein a dividing cylinder is provided, which has a first hydraulic chamber and a second hydraulic chamber divided from the first by a dividing piston, wherein the first hydraulic chamber has a first port, which is connected to the master cylinder, and a second port, which is connected by a simulation valve to a line leading to the wheel brakes, and the second hydraulic chamber is connected by a shut-off valve to the low-pressure storage chamber, and an orifice is disposed in a connection line between the simulation valve and the low-pressure storage chamber.

### CROSS-REFERENCE TO RELATED APPLICATIONS

This application is a national stage of International Application No. PCT/EP2010/001034 filed Feb. 18, 2010, the disclosures of which are incorporated herein by reference, and which claimed priority to German Patent Application No. 10 2009 009 647.7 filed Feb. 19, 2009, the disclosures of which are incorporated herein by reference.

### BACKGROUND OF THE INVENTION

A brake unit for a land vehicle is provided in a hydraulic single- or multi-circuit brake system for controlling the braking system of vehicles that are equipped exclusively, or in addition to an internal combustion engine, with an electrical machine in the drive train. A hydraulic brake system for such motor vehicles is moreover described. Brake systems and their brake units are also increasingly equipped with regenerative braking functionality, wherein the hitherto customary safety- and comfort functions of the brake systems and brake units thereof, such as driver-independent braking (antilock braking system, traction control, electronic stability program, etc.), are to be retained.

In the past the electrical energy required in motor vehicles was generated almost entirely from fuel (petrol or diesel). There is however, for example in the case of electrically operated rail-mounted vehicles, the concept of converting the kinetic energy released during braking—instead of into frictional heat—back into electrical (potential) energy. Now, by means of corresponding control devices in motor vehicles too, during braking phases at least some of the braking energy is to be recycled for recharging the vehicle battery (or more precisely, the accumulator).

From EP-A 595 961, and corresponding U.S. Pat. No. 5,472,264A, both of which are incorporated by reference herein, a braking system for a vehicle with electric drive is known, which comprises a conventional brake system provided with hydraulically actuated friction brakes as well as an electro-regenerative brake system. The electro-regenerative brake system in this case utilizes the electrical drive machine(s) of the motor vehicle for braking and for recovering energy during a braking operation. In this arrangement the brake force fraction of the hydraulic friction brake is adapted during a braking operation to the behaviour of the regenerative brake with a view to optimum energy recovery. For this purpose, the brake force to be adjusted at the driven wheels is determined from the degree of actuation of the brake pedal, while the non-driven wheels are braked by means of the hydraulics in a conventional manner directly as a function of the pedal actuation. For the driven wheels the, in the instantaneous operating state, maximum usable brake force fraction of the regenerative brake is determined from operating variables and the defined brake force is adjusted by means of corresponding activation of the drive motor. If the required brake force exceeds the maximum usable brake force fraction, the exceeding brake force fraction is adjusted by means of the friction brake.

For the driven wheels an uncoupling of the hydraulics from the pedal actuation is provided, whereas for the non-driven wheels there is the conventionally direct, hydraulic control. This is a very complex braking system, the behaviour of which is not very comfort-oriented.

Further technical background is revealed by the documents DE 41 24 496 A, and corresponding U.S. Pat. No. 5,472,264A, both of which are incorporated by reference herein, DE 10 2006 060 434 A1, DE 10 2006 033 890 A1, U.S. Pat. No. 5,924,775 A and DE 102 03 836 A1, and corresponding U.S. Pat. No. 6,851,762B2, both of which are incorporated by reference herein.

From vehicle manufacturers there is a growing demand for the provision of regenerative braking systems that also permit electronic stability control (so-called ESC-R brake systems). Against this background, one problem is to indicate measures for designing and functionally developing the braking system of a vehicle provided with an electrical machine in or at the drive train that increase the comfort of the braking operation for the driver, may have a positive influence upon the control quality and noise generation during regulation of the pressure in the regenerative electronic stability control mode (=ESC-R mode) and/or may be realized in a cost-effective and space-saving manner.

### BRIEF SUMMARY OF THE INVENTION

As a solution to this problem a brake unit for a hydraulic, single- or multi-circuit brake system of a land vehicle with electric drive is indicated for carrying out regenerative braking by means of at least one electrical machine in or at the drive train of the vehicle as well as braking by means of at least one friction brake. A brake pedal and at least one sensor are used to detect a braking request of the driver. A master cylinder is used to feed pressurized hydraulic fluid into at least one brake circuit in accordance with the braking request. In the brake system a dividing or separating cylinder is provided, which has a first hydraulic chamber and a second hydraulic chamber separated from the first by means of a dividing or separating piston. The first hydraulic chamber has a first port, which is connected to the master cylinder, and a second port, which is connected by a simulation valve to a line leading to the wheel brakes. The second hydraulic chamber is to be connected to, and divided from, the low-pressure storage chamber by means of a shut-off valve. In a connection line between the simulation valve and the low-pressure storage chamber an orifice is disposed.

The orifice may be disposed in the connection line between the simulation valve and a shut-off valve disposed upstream of the low-pressure storage chamber.

A pressure control valve may be associated with the simulation valve and is oriented in such a way that, when the simulation valve is blocked, it allows hydraulic fluid to flow off from the brake circuit towards the master cylinder.

The simulation valve may have a spring-actuated let-through position and an electromagnetically adjustable blocked position. The dividing piston of the dividing cylinder may be loaded by a spring arrangement in order to exert a yielding counterforce against hydraulic fluid coming out of the master cylinder.

The simulation valve may be devised during a regenerative braking operation to move as a result of electromagnetic actuation into its blocked position, so that hydraulic fluid coming out of the master cylinder flows into the first hydraulic chamber of the dividing cylinder and no hydraulic fluid flows into the wheel brakes.

The dividing cylinder may form together with the shut-off valve between the master cylinder and the wheel brakes as well as the storage chamber a releasable or blockable dividing chamber, by means of which the volume of hydraulic fluid corresponding to the braking request of the driver flows during a regenerative braking operation, not into the wheel brakes, but into the storage chamber.

The spring arrangement may be formed by a plurality of springs equipped with different spring properties.

By a connection line from the let-through valve to a shut-off valve a fluid path in the direction of the low-pressure storage chamber may be provided, in which the throttling orifice may be disposed.

A connection line may be provided from the let-through valve to a shut-off valve, wherein the throttling orifice may be disposed in a fluid path from this connection line in the direction of the second hydraulic chamber of the dividing cylinder.

The throttling orifice may, when hydraulic fluid is flowing out of the brake circuit towards the master cylinder or the low-pressure storage, cause a back-pressure behind the shut-off valve that increases the discharge pressure behind the shut-off valve out of the wheel brakes.

By means of the low-pressure storage chamber the hydraulic fluid is made available directly, both in terms of time and place, to the inlet side of the pump, so that an—even creeping, as opposed to abrupt—change from a regenerative braking operation to a hydraulic friction braking operation, or vice versa, may be carried out very rapidly.

As soon as the braking request decreases, the pressure reduction in the dividing chamber occurs via the still open valves or via the non-return valves. If during a regenerative braking operation the braking request exceeds the braking torque that may be taken up by the electrical machines of the vehicle—for example in the case of a panic braking operation, or if the low-pressure storage is completely full—the shut-off valves are opened so that pressure is applied to the friction brakes at the wheels of the vehicle.

By virtue of this solution, given the use of an only slightly modified conventional braking system with friction brakes, optimum utilization of the potential of regenerative braking in electric land vehicles, vehicles with a hybrid drive or vehicles with an adequately dimensioned starter-generator in or at the drive train may be achieved.

During braking the electrical machines recover the greatest possible amount of energy. Braking requirements exceeding the regenerative braking are covered by the friction brake.

During normal operation the valves may be situated in their non-activated basic position, so that the inlet valves are open and the outlet valves are closed.

In the ABS situation the appropriate valves may be controlled in an open or closed state and the pump may be activated in order to build up, reduce or maintain pressure in the relevant wheel brake or brakes.

In the antilocking- or traction control situation the electrohydraulically controlled braking operation is superimposed on the regenerative mode, wherein the parts responsible for the ABS/TC mode, such as valves, pump, low-pressure storage of the brake system, are at least almost uncoupled from the master cylinder and the brake pedal by the closed valves and the simulation dividing cylinder.

Other advantages of this invention will become apparent to those skilled in the art from the following detailed description of the preferred embodiments, when read in light of the accompanying drawings.

### BRIEF DESCRIPTION OF THE DRAWINGS

FIG. 1 shows a diagrammatic representation of a hydraulic brake system in a hydraulic braking system with ABS/ASC function.

### DETAILED DESCRIPTION OF THE INVENTION

The aim of the proposed solution is, in electric and/or hybrid vehicles, to recover as much as possible of the energy that is released during braking. As the regenerative braking by means of the drive machine of the vehicle is insufficient to cover all of the braking requirements of the vehicle, the vehicle is additionally equipped with a friction brake. The regenerative braking and the friction brake are to be tuned to one another in such a way that as much energy as possible may be recovered, while at the same time the other functions of a braking system (ABS, VSC, TC, ESC, etc.) are likewise available.

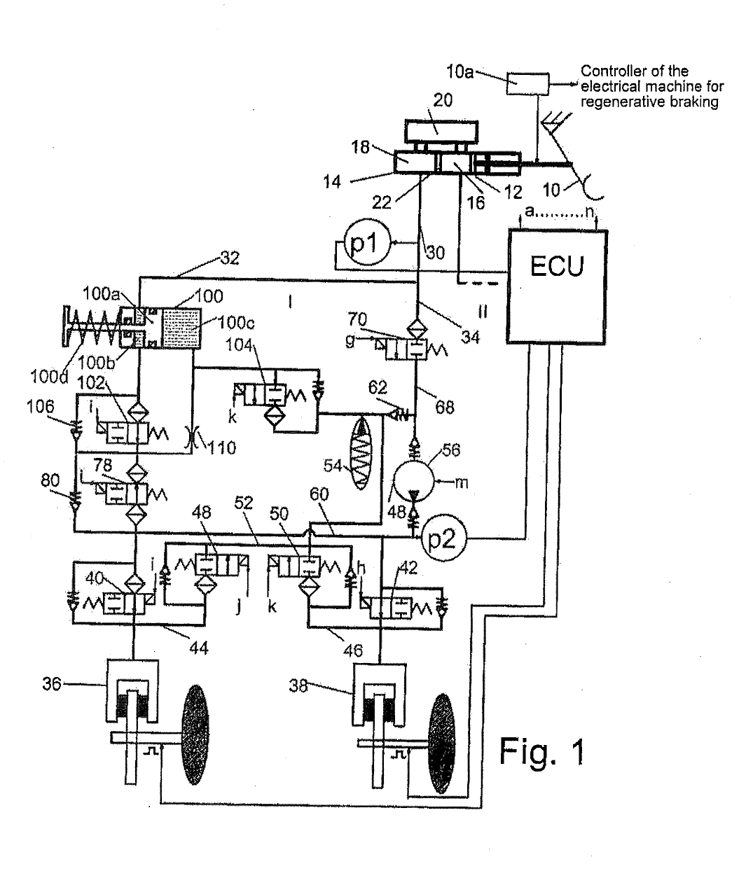

For this purpose, FIG. 1 shows a diagrammatic representation of a brake system with a diagonal brake force split, in a hydraulic braking system with ABS/TC/ESC-R functionality. A brake pedal 10 that is to be actuated by a driver actuates an input element of a master cylinder 14. The master cylinder 14 has a first cylinder chamber 16 and a second cylinder chamber 18, both of which communicate with a fluid reservoir 20. The two cylinder chambers 16, 18 are separated from one another by an intermediate piston 22 and each supply one brake circuit I, II. A pneumatic or hydraulic brake booster may for example also be disposed upstream of the master cylinder in order to boost the pedal force that is introduced at the brake pedal and acts upon the master cylinder 14.

At the brake pedal 10 for regenerative braking purposes at least one measuring device 10a is provided, which supplies a measurement of the displacement and/or force of actuation of the brake pedal 10 by the driver (=braking request). The measuring device 10a delivers a trigger signal to the controller of the electrical machine in/at the drive train for the regenerative braking operation. In the following only the one—in FIG. 1, the left—brake circuit I is described, while the other brake circuit II, because it is identical in functionality and structure to the brake circuit I, may be left out of the discussion.

A brake line 30 emanating from the master cylinder 14 branches into two brake lines 32 and 34, which lead to the wheel brakes 36 and 38 respectively. Depending on which wheel brakes of the vehicle are supplied by which brake circuit, the result is a different front-/rear axle split, i.e. the one brake circuit supplies the wheel brakes of the front axle and the other brake circuit supplies the wheel brakes of the rear axle, or a diagonal split, i.e. each brake circuit supplies one wheel brake of the front axle and the diagonally opposite wheel brake of the rear axle.

In each of the brake lines 32 and 34 a 2/2-way valve is provided as inlet valve 40 and/or 42 and has a spring-actuated let-through position and an electro-magnetically adjustable blocked position. Between the inlet valve 40 and/or 42 and the associated wheel brake 36 and/or 38 in each case a return line 44 and/or 46 emanates. In each of these return lines 44 and 46 a 2/2-way valve is disposed as outlet valve 48 and/or 50. The outlet valves 48 and 50 have a spring-actuated blocked position and an electromagnetically adjustable let-through position. The return lines 44 and 46 are combined at the outlet sides of the outlet valves 40 and 50 into a common return line 52, to which a fluid pressure accumulator 54 acting as a low-pressure storage chamber is connected. The brake circuit moreover comprises a pump 56 that generates high pressure. This pump 56 is connected at its inlet side to the return line 52 and the low-pressure storage chamber 54. At the discharge end the pump 56 is connected by a feed line 60 to the inlet side of the inlet valves 40 and 42.

In the return line 52 between the low-pressure storage chamber 54 and the pump 56 a non-return valve 62 is moreover disposed, which, when the outlet valve 48 or 50 is open, prevents the development of low pressure in the wheel brake cylinders 36 and/or 38. Leading to the inlet side of the pump 56 there is in addition to the return line 52 an intake line 68, in which a 2/2-way valve is situated as an intake control valve 70 having a spring-actuated blocked position and an electromagnetically adjustable let-through position. At the inlet side, this intake control valve 70 is connected to the brake line 30.

In the fluid path between the feed line 60 and the brake line 32 emanating from the master cylinder 14 a 2/2-way valve is provided as a shut-off valve 78, which is bridged by a pressure control valve 80. The shut-off valve 78 has a spring-actuated let-through position and an electromagnetically adjustable blocked position. The pressure control valve 80 in a situation independent of a braking request, for example a traction control situation, allows brake fluid coming from the wheel brakes to flow in the direction of the master cylinder 14 even in the case of an electromagnetically enabled blocked position of the shut-off valve 78.

In the brake line 32 emanating from the master cylinder 14 a dividing or separating cylinder 100 acting as a simulator is disposed upstream of the shut-off valve 78. The dividing or separating cylinder 100 has a dividing or separating piston 100a for separating two hydraulic chambers 100b and 100c from one another. The first hydraulic chamber 100b is connected at the inlet side by the brake line 30 to the master cylinder 14 and at the outlet side by a simulation valve 102, which is bridged by a pressure control valve 106, to the shut-off valve 80. This simulation valve 102 has a spring-actuated let-through position and an electromagnetically adjustable blocked position. The second hydraulic chamber 100c of the dividing cylinder 100 has only one port and is connected by a shut-off valve 104 via the return line 52 and the low-pressure storage chamber 54. This shut-off valve 104 is bridged by a pressure control valve, which opens in the direction of the hydraulic chamber 100c of the dividing cylinder 100, and has a spring-actuated blocked position and an electromagnetically adjustable let-through position.

The pressure control valve 106 associated with the simulation valve 102 is oriented in such a way that during a regenerative braking operation, i.e. when the simulation valve 102 is blocked, for example in a suddenly occurring traction control situation, it allows hydraulic fluid to flow out of the brake circuit towards the master cylinder 14 and the hydraulic reservoir 20 thereof.

The dividing piston 100a of the dividing cylinder 100 is loaded by a spring arrangement 100d in order—in the situation of regenerative braking—to exert a yielding counterforce against hydraulic fluid coming out of the master cylinder 14. During a regenerative braking operation the simulation valve 102 is blocked electromagnetically in order to take up the hydraulic fluid coming out of the master cylinder 14 in the first hydraulic chamber 100b and prevent the hydraulic fluid from flowing into the wheel brakes.

The dividing cylinder 100 together with the shut-off valve 104 has the effect that between the master cylinder 14 and the wheel brakes as well as the storage chamber 54 a releasable or blockable dividing chamber is formed, by means of which during a regenerative braking operation the volume of hydraulic fluid corresponding to the braking request of the driver is not fed into the wheel brakes but may flow into the storage chamber 54. From there it may be retrieved directly with practically no time delay in the course of a hydraulic friction braking operation if the regenerative braking operation is not sufficient to apply the required braking torque “to the road”. The spring arrangement 100d may be formed by a plurality of springs, which are equipped with different spring properties (spring constants) and also co-determine the pedal response presented to the driver.

In order in regenerative braking phases to convey as realistic a “braking feel” as possible, one or more additional orifices 110 with a correspondingly dimensioned flow cross section are disposed in the hydraulic path between the connection of the let-through valve 102 and the shut-off valve 78 and the second hydraulic chamber 100c of the dividing cylinder 100. More precisely, the throttling orifice 110 is provided in the discharge path from the shut-off valve 78 through the shut-off valve 104 in the direction of the low-pressure storage chamber 54 in order to have a positive influence upon the control quality and the noise generation during the regulation of pressure in the ESC-R mode. A further advantageous effect is that pedal reactions caused by sudden control changes may be effectively prevented by means of such an orifice.

This throttling orifice 110 is situated, not in the main path between the master cylinder 14 and the wheel brakes, but in the secondary path in the direction of the second hydraulic chamber 100c of the dividing cylinder 100 and low-pressure storage chamber 54. For this reason, this throttling orifice 110 does not impede the discharge of hydraulic fluid from the wheel brakes during a hydraulic friction braking operation. In the course of the pressure regulation this throttling orifice 110 generates, behind the shut-off valve 78 that regulates the pressure in the wheel brakes, a back-pressure that increases the discharge pressure behind the shut-off valve 78 from the wheel brakes and hence prevents or at least reduces cavitation effects at the valve seat and hence increases the control quality and reduces the noise generation. In this case, the flow cross section of this throttling orifice 110, in view of the back-pressure/discharge pressure behind the shut-off valve 78, is so dimensioned that even at low temperatures a rapid, controlled pressure reduction is not impeded.

During normal operation the valves are in their non-activated basic position. This means that the inlet valves 40 and 42 are open and the outlet valves 48 and 50 are closed. The pressure instigated by the driver through actuation of the pedal is therefore applied to the corresponding wheel brakes. In the ABS situation, the corresponding valves are controlled into an open or closed state and the pump 56 is activated in order to build up, reduce or maintain pressure in the relevant wheel brake or brakes.

If one or more of the driven wheels of the vehicle has an excessive drive slip, i.e. there is a situation requiring traction control, the outlet valve associated with the slip-affected wheel is switched into its blocked position and the intake valve is switched into its let-through position. By activating the pump, without pedal actuation hydraulic fluid from the hydraulic reservoir is drawn in and introduced through the respective open inlet valve into the relevant wheel brake cylinder or cylinders. Thus, independently of the brake pedal actuation pressure may be built up in the wheel brakes. Pressure reduction is effected by opening the outlet valves, closing the intake valves and opening the inlet valves.

In addition to the hydraulically actuated friction brakes described above and represented in the FIGURE, in the electric- or hybrid vehicle regenerative braking is possible by means of one or more electrical machines used to drive the motor vehicle. In this case, the electrical machine(s) operated as a generator is/are activated to charge the accumulator(s). In this case, for controlling the electrical machine(s) as a rule an individual control unit 10a is provided. This is in data communication with the control unit that controls the hydraulic braking system.

This control unit for the electrohydraulic braking system receives a measurement of the brake pedal actuation, variables of the wheel speeds of the vehicle wheels and the pressure in the individual vehicle brakes as well as the pressure at the output of the master cylinder. A bus, for example a serial bus, is moreover used as a connection to the engine control unit to receive a variable, which represents the braking torque adjusted by the regenerative brake, and to supply a variable that represents the braking torque to be adjusted. Output control lines are further provided for controlling the various valves and the pump.

In the control unit that controls the electrohydraulic braking system the braking operations of friction brake and regenerative brake are coordinated. For this purpose, at least one signal reproducing the brake pedal actuation is supplied to the control unit. If the electrical system is in operation, the electrical machine(s) may brake the vehicle. At the start of a normal braking operation (i.e. not an emergency- or panic braking operation), upon actuation of the brake pedal the valves in the hydraulic braking system are activated in such a way that no brake pressure build-up or only a slight brake pressure build-up that does not lead to any, or any significant, hydraulic braking effect occurs in the wheel brake cylinders. Rather, a regenerative braking operation is initiated. For this purpose, the simulation valve 102 is moved into its electromagnetically adjusted blocked position. The intake control valve 104 is also moved into its electromagnetically adjusted blocked position. The valve 102 connected in series to the dividing cylinder 100 is moreover moved into its spring-actuated let-through position.

The brake pedal actuation by the driver allows hydraulic fluid to flow into the master-cylinder-side part of the dividing cylinder 100, while the part of the dividing cylinder 100 that is separated from the master cylinder 14 is compressed and the hydraulic fluid situated therein escapes into, and at least partially fills, the low-pressure storage chamber 54. In dependence upon the actuation of the brake pedal and optionally further operating variables, the braking request of the driver is derived. This braking request is converted to a setpoint braking torque, which is then converted in the control unit for the electrical machine to appropriate operating parameters for this machine. As soon as the storage chamber is full without the braking request being terminated or decreasing, in the case of an ongoing braking request in addition to the regenerative braking operation brake pressure is built up in the hydraulic brakes and hence a superimposed braking operation by means of the friction brake is achieved in accordance with the braking request.

If the braking request decreases or is terminated before the storage chamber is completely full, the pressure reduction in the simulator and/or the storage chamber is effected in such a way that the simulation valve 102 remains in its blocked position and the intake control valve 104 adopts or remains in its let-through position. The valve 102 connected in series to the dividing cylinder 100 moreover remains in its let-through position.

By virtue of the proposed solution with the throttling orifice 110, the pedal characteristic that is familiar to the driver is maintained. In particular, in the regenerative braking range, despite the low brake pressure that corresponds to the spring action in the simulator (and optionally the counterpressure of the storage chamber), no pedal response other than the one that is anticipated is produced.

There now follows a description of another variant for the purpose, in a hydraulic, single- or multi-circuit brake system, of increasing the comfort for the driver and reducing the weight and/or the installation space requirement in a land vehicle, the land vehicle being equipped with an electric drive for carrying out regenerative braking by means of at least one electrical machine in or at the drive train of the vehicle as well as braking by means of at least one friction brake.

Conventional variants of an ESC-R brake system have a brake pedal, a vacuum brake booster, a master cylinder and the electrohydraulic control unit, downstream of which the friction brakes are disposed.

In this case, the electrohydraulic control unit contains for example a pump and an upstream control valve for implementing the regeneration facility. With the increasing prevalence of direct injection internal combustion engines and start-stop automatics there is a diminishing availability of a vacuum in the vehicle. This is combated by a separate vacuum pump having the appropriate specifications in terms of installation space, weight, etc.

It has now been discovered that in a hybrid vehicle equipped with an ESC-R brake system in connection with the dividing cylinder/simulator in the situation of active regenerative braking operations there is merely the task of conveying the necessary pedal force sensation to the driver. The necessary braking torque is generated by the electrical machine in/at the drive train and/or with the aid of the hydraulic unit via the wheel brakes.

As the regenerative braking operations make up by far the greatest proportion of all of the braking operations of a hybrid vehicle, and compared to these the hydraulic normal braking operations occur only very rarely, in a regenerative ESC control unit of the design proposed above it is possible to leave out the vacuum brake booster and design the brake unit for these normal braking operations to comply with (statutory or vehicle manufacturer's) minimum specifications of for example 0.65 g with 500 N pedal force.

To alleviate or eliminate this problem it is now proposed, in the non-regenerative operating situation, by means of the control unit for the electrohydraulic braking system to open the inlet valve 40 and/or 42 disposed upstream of the respective wheel brake and start the high-pressure-generating pump 56. It is thereby possible to provide missing brake pressure by means of fluid fed by the pump 56. Finally, this allows the vacuum booster to be left out entirely or at least significantly reduced in size compared to the previous dimensions. Furthermore, the hydraulic transmission ratio in the brake cylinder is reduced and the spring constant of the spring arrangement in the simulator dividing cylinder is reduced. Since by virtue of these measures the piston stroke of the piston in the simulator dividing cylinder may remain unchanged in relation to the brake pedal displacement, during a regenerative braking operation there is also always enough brake fluid in the low-pressure storage chamber in order if need be to build up, in addition to the regenerative braking torque taken up by the electrical machine in/at the drive train, additional braking torque by means of the friction brakes. However, during a normal braking operation the driver would then sense a markedly harder brake pedal, and for a specific braking operation a markedly higher pedal force would be needed to comply with the minimum specification.

Alternatively, the vacuum brake booster may be reduced in size and the hydraulic transmission ratio in the master cylinder may be reduced and the master cylinder diameter retained, so that only the full-output drive point drops accordingly.

Up to this reduced full-output drive point the pedal sensation remains unchanged. During a normal braking operation, from this full-output drive point on the hydraulic braking mode might be activated in order to keep the pedal sensation and the deceleration of the vehicle at the usual level, even if this would not be absolutely necessary for the (statutory or vehicle manufacturer's) minimum specification. In the case of regenerative braking, opening of the inlet valve for the hydraulic braking mode function is however problematical.

If the pressure level in the brakes at the time of deployment of the hydraulic braking mode is below the master cylinder pressure, then a brief opening of the inlet valve will be immediately perceptible at the brake pedal, with opening for a longer time leading to falling-through of the brake pedal. If the inlet valve remains open, the pressure in the brakes will tend to rise to the master cylinder pressure. The shut-off valve 78, which corrects the pressure that is then too high, discharges the pressure into the low-pressure fluid storage 54.

A further variant provides that the vacuum brake booster be reduced in size, the transmission ratio reduced, and the diameter of the master cylinder correspondingly reduced. The pedal sensation for the driver therefore remains unchanged during regenerative- and normal braking operations.

For the regenerative braking the dividing chamber would have to be provided with an increased hydraulic transmission ratio so that, despite a shorter stroke, if need be always enough brake fluid for the brake pressure build-up is displaced into the low-pressure fluid storage. For a normal braking operation the driver would however at a specific pedal force sense a markedly lower deceleration and the stroke-volume rating between master cylinder and brake would be critical in particular in the event of brake fading or even brake circuit failure.

On the whole, for ESC-R braking systems, i.e. regenerative, electrohydraulic braking systems that also permit electronic stability control, the simulation dividing piston offers the possibility of realizing the braking operations by means of fluid that is supplied by the fluid pump, wherein the response and the characteristic of the brake pedal is determined by the spring arrangement of the simulation dividing cylinder, the hydraulic transmission ratio of the master cylinder and, if provided, by the vacuum brake booster.

In the situation of a regenerative normal braking operation, the brake pedal experiences a pedal force that corresponds to the driver request and results in brake fluid being fed into the dividing cylinder and accordingly into the low-pressure fluid storage. The pump in the situation of a subsequent hydraulic normal braking operation, for example because the low-pressure fluid storage is full or the regenerative braking operation is unable to provide sufficient braking torque, removes fluid from the low-pressure fluid storage and feeds it into the wheel brakes. In a fault situation, in which the pump is not feeding, for example because of an electric power failure, the blocking valves move into their de-energized position. In this case, the braking request of the driver leads directly to fluid being fed from the master cylinder into the wheel brakes.

The problem is that on the one hand the required installation space for the braking system is to be reduced, on the other hand the comfort for the driver is to be maintained or even increased and there is always to be compliance with the statutory or vehicle manufacturer's specifications with regard to vehicle deceleration.

The discovery is then based on the fact that, with the ESC-R brake system proposed above, by virtue of the simulation dividing cylinder thereof in the normal (regenerative) braking situation, on the one hand, the driver request may be detected without feeding the corresponding fluid into the wheel brakes and, on the other hand, the spring-, throttling orifice arrangement at the simulation dividing cylinder as well as the transmission ratio of the master cylinder may be configured in such a way that the desired brake pedal characteristic may be achieved. At the same time this configuration of the master cylinder may also satisfy the mandatory marginal condition, namely compliance with the vehicle manufacturer's and/or statutory minimum specifications regarding braking deceleration in a fault situation, in which the simulation dividing cylinder fails or there is a total or partial failure of electrical components.

A substantial comfort gain arises from the fact that modern ABS/TC-ESC brake units in the antilocking- or traction control situation immediately switch off the regenerative mode and switch to electrohydraulic mode. However, as these modes of operation also occur relatively often during normal driving, the frequent change from regenerative mode is linked to perceptible efficiency losses and increased fuel consumption as well as a corresponding emission of pollutants.

The present ESC-R brake system permits and provides, in the antilocking- or traction control situation, the superimposing of the electrohydraulically controlled braking operation on the regenerative mode. As a result of this, on the one hand because of the blocked simulation dividing cylinder the driver does not sense or barely senses the pulsating of the ABS/TC mode at the brake pedal, and on the other hand in the antilocking- or traction control situation the regenerative mode does not have to be switched off immediately, thereby increasing the efficiency of the regenerative mode. This is because the part of the brake system that is responsible for the ABS/TC mode is uncoupled in a practically reaction-free manner from the master cylinder and the brake pedal by the closed valves and the simulation dividing cylinder.

The description of the embodiments according to the proposed solutions that is provided above and in the claims is used merely for illustrative purposes and not for the purpose of limiting the proposed solutions. Widely differing changes and modifications are possible without departing from the scope of the proposed solution or equivalents thereof.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. Brake unit for a hydraulic, single- or multi-circuit brake system of a land vehicle with electric drive for carrying out regenerative braking by means of at least one electrical machine in or at the drive train of the vehicle as well as braking by means of at least one friction brake comprising:
a brake pedal;
at least one sensor for detecting a braking request of the driver;
a master cylinder for feeding pressurized hydraulic fluid into at least one brake circuit in accordance with the braking request;
a dividing cylinder which has a first hydraulic chamber and a second hydraulic chamber divided from the first hydraulic chamber by a dividing piston
with the first hydraulic chamber having a first port, which is connected to the master cylinder, and a second port, which is connected by a simulation valve to a line leading to the wheel brakes, and
with the second hydraulic chamber is connected by a shut-off valve to a low-pressure storage chamber; and
an orifice disposed in a connection line between the simulation valve and the low-pressure storage chamber.

2. Brake unit according to claim 1, wherein the orifice is disposed in the connection line between the simulation valve and a shut-off valve disposed upstream of the low-pressure storage chamber.

3. Brake unit according to claim 1, wherein a pressure control valve is associated with the simulation valve and oriented in such a way that, when the simulation valve is blocked, it allows hydraulic fluid to flow out of the brake circuit towards the master cylinder.

4. Brake unit according to claim 1, wherein the simulation valve has a spring-actuated let-through position and an electromagnetically adjustable blocked position.

5. Brake unit according to claim 1, wherein the dividing piston of the dividing cylinder is loaded by a spring arrangement in order to exert a yielding counterforce against hydraulic fluid coming out of the master cylinder.

6. Brake unit according to claim 1, wherein the simulation valve is devised during a regenerative braking operation to move as a result of electromagnetic actuation into a blocked position so that the hydraulic fluid coming out of the master cylinder flows into the first hydraulic chamber of the dividing cylinder and no hydraulic fluid flows into the wheel brakes.

7. Brake unit according to claim 1, wherein the dividing cylinder together with the shut-off valve between the master cylinder and the wheel brakes as well as the storage chamber forms a releasable- or blockable dividing chamber, by means of which the volume of hydraulic fluid corresponding to the braking request of the driver flows during a regenerative braking operation, not into the wheel brakes, but into the storage chamber.

8. Brake unit according to claim 5, wherein the spring arrangement is formed by a plurality of springs that are equipped with different spring properties.

9. Brake unit according to claim 1, wherein the shut-off valve is a first shut-off valve and the connection line from the simulation valve also extends to a second shut-off valve with the throttling orifice being disposed in a fluid path extending from the connection line before the second shut-off valve to the low-pressure storage chamber.

10. Brake unit according to claim 1 wherein the shut-off valve is a first shut-off valve and the connection line from the simulation valve also extends to a second shut-off valve with the throttling orifice being disposed in a fluid path extending the from connection line before the second shut-off valve in the direction of the second hydraulic chamber of the dividing cylinder.

11. Brake unit according to claim 9, wherein the throttling orifice is so dimensioned that it causes a back pressure behind the shut-off valve that increases the discharge pressure behind the shut-off valve out of the wheel brakes.

12. Brake unit according to claim 1, wherein the brake unit also includes an intake control valve disposed in a supply line connecting a pump to the master cylinder and further wherein hen an antilocking- or traction control situation the electrohydraulically controlled braking operation is superimposed on the regenerative mode with the brake components responsible for the ABS/TC mode, such as valves, pump, low-pressure storage of the brake system, uncoupled from the master cylinder and the brake pedal by closure of the simulation, shut-off and intake control valves and the dividing cylinder.
